(19) United States
(12) Patent Application Publication
(10) Pub. No.: US 2012/0324730 A1
(43) Pub. Date: Dec. 27, 2012

(54) COMPOSITE MATERIAL WHEEL RIM STRUCTURE

(75) Inventor: Shih Hung LIN, Tainan County (TW)

(73) Assignee: Taiwan Hodaka Industrial Co., Ltd., Tainan County (TW)

(21) Appl. No.: 13/602,441

(22) Filed: Sep. 4, 2012

Related U.S. Application Data
(62) Division of application No. 12/588,378, filed on Oct. 14, 2009.

(30) Foreign Application Priority Data
Oct. 14, 2008 (TW) 097218351

(51) Int. Cl. B23P 15/00; B23P 17/00

(52) U.S. Cl. 29/894.33; 29/894.351

(57) ABSTRACT

A composite material wheel rim structure includes an inner rim surface and a rigid inner lining material encased by the inner rim surface to form an integrated composite structure capable of sustaining the drilling of spaced threaded holes of desired orientations and diameters for threaded engagement with corresponding attachment caps of wheel spokes so that the tightness of each spoke may be varied by the depth. The cap is threaded into the threaded hole.

### CROSS REFERENCE TO RELATED APPLICATION

This is a divisional of U.S. application Ser. No. 12/588,378, filed on Oct. 14, 2009, which claims priority to Taiwanese Application No. 097218351, filed on Oct. 14, 2008, the entire contents of which are incorporated by reference herein.

### BACKGROUND OF THE INVENTION

1. Field of the Invention

This invention relates generally to a composite material wheel rim structure wherein an inner rim surface of the composite material wheel rim is connected to each spoke, and the location of each connection is capable of sustaining the drilling of a threaded hole for threadedly joining an attachment cap of the spoke and adjusting the tightness of the spoke.

2. Description of the Prior Art

A bike wheel rim includes an outer rim surface which joins the tire and an inner rim surface connected to a wheel hub in the center of the wheel rim through a radial arrangement of spokes. The spokes are individually capable of being adjusted for tightness. The connection between the spoke and the inner rim surface of the wheel rim is carried out by threadedly joining an attachment cap to a threaded hole, where the attachment cap is provided with threads on its external side and is located at one end of the spoke, while the threaded hole is located at a corresponding location at the inner rim surface of the wheel rim. By adjusting the depth that the attachment cap is threadedly joined to the threaded hole, the tightness of a spoke can be correspondingly adjusted. Composite materials have lightweight and strength by nature, and are the preferred materials for the bike frame. However, when a composite material is used to produce the wheel rim, it will not have sufficient strength for sustaining the drilling of threaded holes at the inner rim surface of the composite material wheel rim for the threaded attachment of the spoke caps. Moreover, cracks are easily created at the drilled spots around the inner rim surface of a composite material wheel rim.

### SUMMARY OF THE INVENTION

The objective of this invention is therefore to provide a composite material wheel rim structure, wherein the composite material wheel rim is connected by each spoke, and the location of each connection is capable of sustaining the drilling of a threaded hole.

The inner rim surface of the composite material wheel rim is engaged by the attachment cap of each spoke, and a rigid inner lining material is encased by the inner rim surface during the manufacture of the composite material wheel rim to form an integrated composite structure, thereby enabling the drilling of threaded holes in the inner lining material. Since the inner lining material is used to sustain the drilling of the threaded holes and the engagement by the attachment caps of the spokes, the inner rim surface of the composite material wheel rim therefore permits the threaded holes to be threadedly engaged by the attachment cap of each spoke for the alignment and adjustment of the tightness of each spoke.

### BRIEF DESCRIPTION OF THE DRAWINGS

FIG. 1 is a sectional view of an exemplary embodiment of this invention before a threaded hole is drilled;

FIG. 2 is a sectional view of FIG. 1 viewing from the line 2-2;

FIG. 3 is a sectional view of a right-slanted threaded hole of the exemplary embodiment of this invention;

FIG. 4 is a sectional view of FIG. 3 viewing from the line 4-4;

FIG. 5 is a sectional view of a left-slanted threaded hole of the exemplary embodiment of this invention;

FIG. 6 is a sectional view of FIG. 5 viewing from the line 6-6;

FIG. 7 is an exploded view of a spoke and the composite material wheel rim of the exemplary embodiment of this invention;

FIG. 8 is a sectional view showing a right-slanted threaded hole of the composite material wheel rim threadedly engaged by a spoke; and

FIG. 9 is a sectional view showing a left-slanted threaded hole of the composite material wheel rim threadedly engaged by a spoke.

### DETAILED DESCRIPTION OF THE INVENTION

To achieve the foregoing objects of the present invention, the invention shall now be described in detail with reference to the following preferred exemplified embodiments and the accompanying drawings.

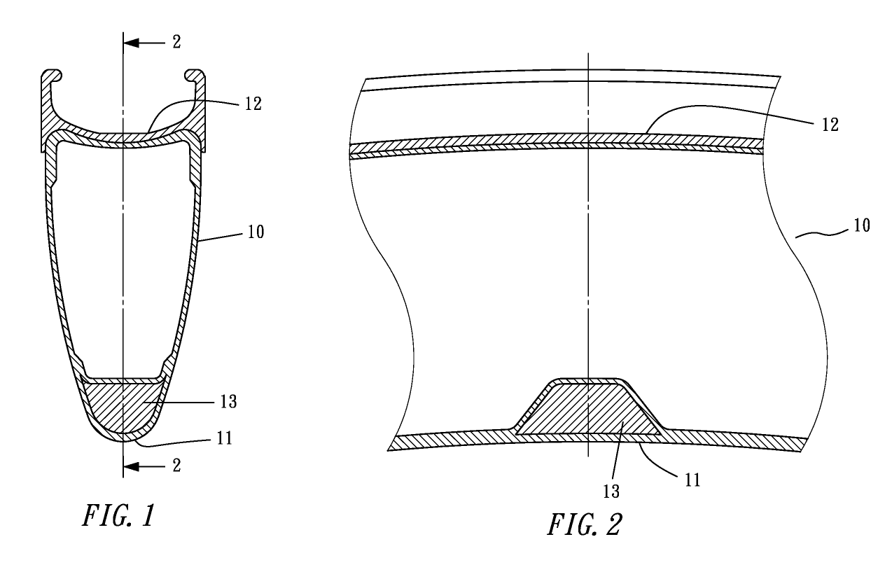

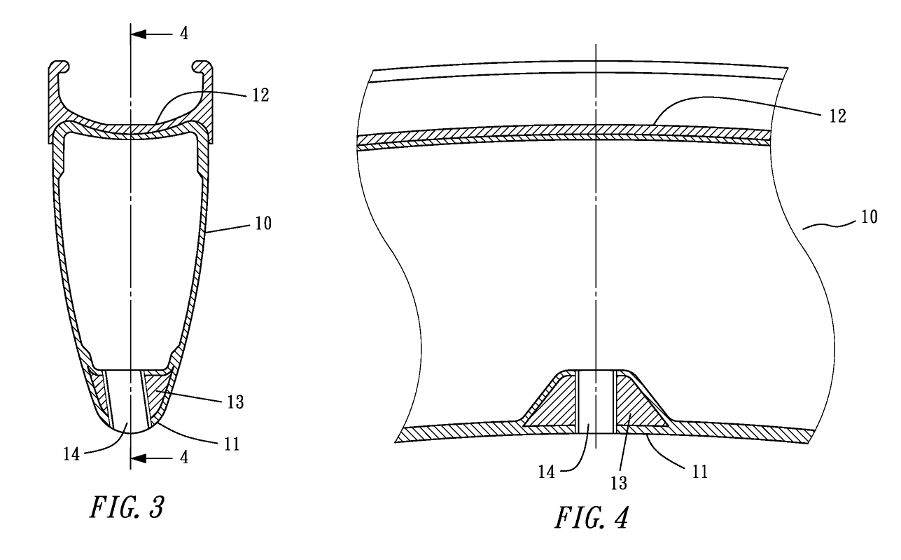

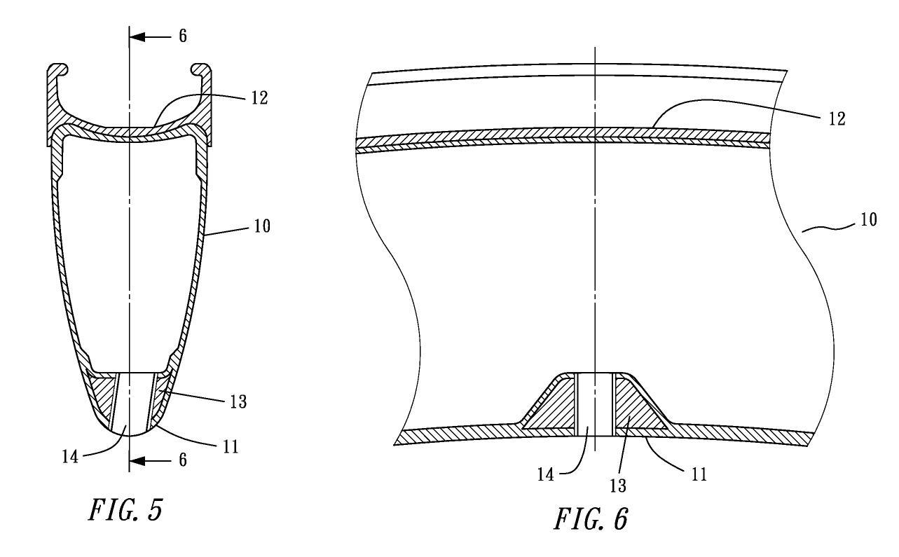

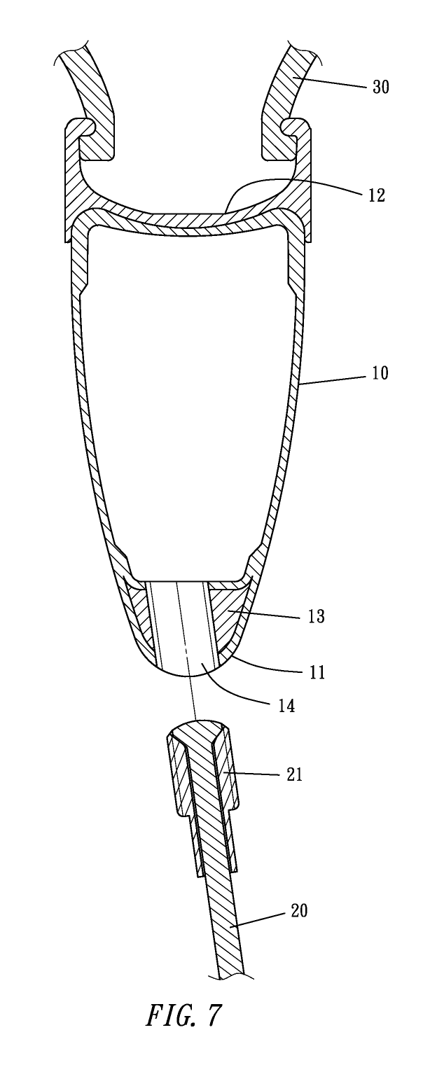

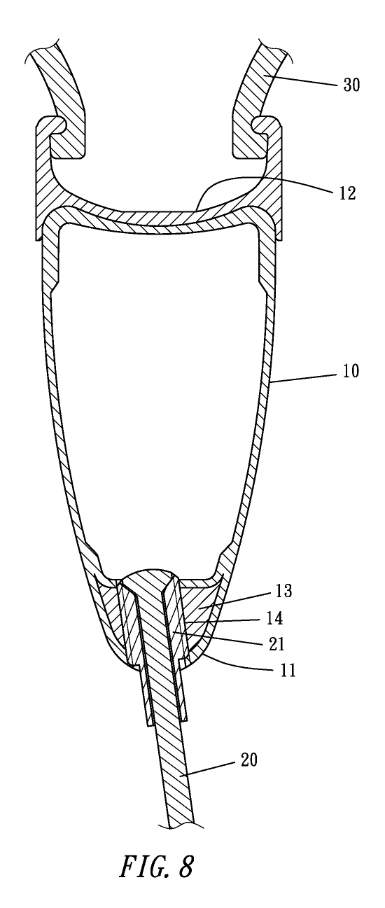

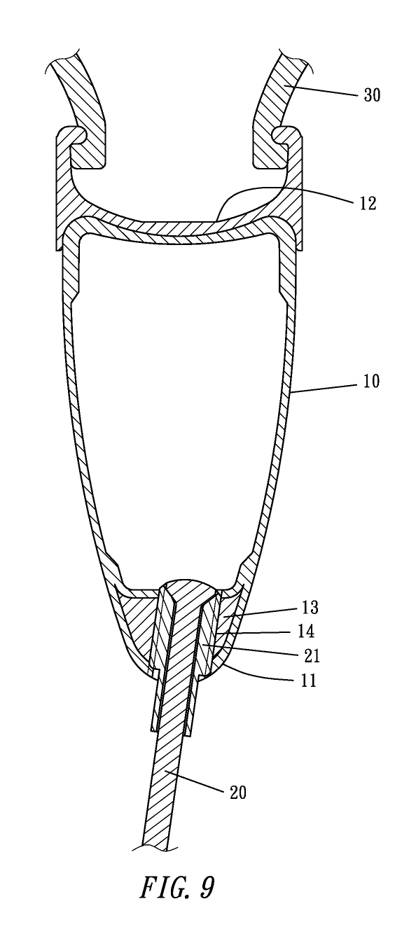

Referring to FIGS. 1 & 2, the composite material wheel rim 10 of a preferred embodiment of this invention is provided with an inner rim surface 11 and an outer rim surface 12. The inner rim surface 11 joins a wheel hub (not shown) by a plurality of spokes 20 (shown in FIG. 7), while the outer rim surface 12 is engaged by a tire 30. The inner rim surface 11 of the composite material wheel rim 10 links to a threaded attachment cap 21 provided at one end of each spoke 20 to the rim, and a corresponding rigid inner lining material 13, preferably of a rigid metallic or plastic substance, is encased by the inner rim surface 11 during the manufacture and shaping of the composite material wheel rim 10 to form an integrated composite structure. This permits the drilling of threaded holes 14 in the rigid inner lining material 13, and the sustaining of the threaded engagement by the attachment caps 21 of the spokes 20 (shown in FIGS. 3˜6). The orientation of a threaded hole 14 of the inner rim surface 11 of the composite material wheel rim 10 is coordinately adjusted subject to the alignment of a corresponding spoke 20 of the wheel hub as shown in FIGS. 3 & 5. The attachment cap 21 of each spoke 20 is threadedly engaged with a threaded hole 14 of the inner rim surface 11 of the composite material wheel rim 10, as shown in FIGS. 7˜9. Since the attachment cap 21 of a spoke 20 is actually in threaded connection with the threaded hole 14, the tightness of a spoke 20 is therefore adjustable by the depth that the attachment cap 21 is threadedly engaged in the threaded hole 14. Accordingly, this invention provides a rigid inner lining material 13 encased by the inner rim surface 11 of the composite material wheel rim 10 to permit drilling of the corresponding threaded holes 14 that threadedly joins to the attachment caps 21 of spokes 20.

What is claimed is:

1. A method for making a composite material wheel rim comprising threaded holes, wherein the method comprises the following steps:
(a) forming a composite material wheel rim by integrating a rigid inner lining with a wheel rim such that the rigid inner lining is encased by the wheel rim at the inner surface of the wheel rim; and
(b) forming a plurality of spaced threaded holes in the inner surface of the composite material wheel rim to produce the composite material wheel rim comprising threaded holes.

2. The method of claim 1, wherein the spaced threaded holes penetrate through the inner surface of the wheel rim into the rigid inner lining.

3. The method of claim 1, wherein each of the spaced threaded holes are oriented at an angle suitable for attachment of a threaded wheel spoke.

4. The method of claim 1, wherein the rigid lining comprises a metallic substance.

5. The method of claim 3, further comprising the following step (c):
(c) attaching one or more threaded wheel spokes to the composite material wheel rim comprising threaded holes by threadedly engaging a first end of a threaded wheel spoke within one of the spaced threaded holes.

6. The method of claim 5, wherein each of the one or more threaded wheel spokes comprises a threaded attachment cap located at the first end of the wheel spoke and is threadedly engaged within the spaced threaded hole via the threaded attachment cap.

7. The method of claim 5, further comprising the following step (d):
(d) attaching a second end of each of the one or more threaded wheel spokes to a wheel hub.
